(19) United States
(12) Patent Application Publication
(10) Pub. No.: US 2012/0101860 A1
(43) Pub. Date: Apr. 26, 2012

(54) PROVIDING BUSINESS INTELLIGENCE

(76) Inventor: Ahmed K. Ezzat, Cupertino, CA (US)

(21) Appl. No.: 12/911,389

(22) Filed: Oct. 25, 2010

(51) Int. Cl. G06Q 10/00

(52) U.S. Cl. 705/7.11

(57) ABSTRACT

The present disclosure provides a computer-implemented method of processing a business intelligence client request in real-time using Unified Information Access System architecture. The method includes receiving a business intelligence client request and acquiring data from a plurality of data sources relevant to the business intelligence client request. A first portion of the data is acquired from a first data source in a first data format native to the first data source, and a second portion of the data is acquired from a second data source in a second data format native to the second data source. The method also includes converting the data into a common data format and storing the data to a common data store. The method also includes processing the business intelligence client request on the common data store.

### BACKGROUND

Enterprises use business intelligence (BI) technologies for strategic and tactical decision making. In many cases the decision-making cycle may span a time period of several weeks, such as in campaign management, or months, such as in improving customer satisfaction. However, competitive pressures are forcing companies to react faster to rapidly changing business conditions and customer requirements. As a result, there is an increasing need to use business intelligence to help drive and optimize business operations on a daily basis and, in some cases, in near real-time. This type of business intelligence is called operational business intelligence.

In traditional business intelligence architectures, an extract-transform-load application is used to collected enterprise transactional data from a variety of data sources, including structured and unstructured data sources. The collected data is processed, for example, semantics are extracted from the unstructured data, and the data loaded into a data warehouse as structured data. The users can then run queries on the data warehouse, generate reports from the data warehouse, and the like.

The process of integrating structured and unstructured data and loading the data into the data warehouse places a significant processing load on the data warehouse. As a result, loading large amounts of data can negatively impact the data warehouse's query processing performance. Therefore, the data warehouse is generally updated periodically during times when it is expected that the data warehouse will not be in use by an end user. In this case, changes in the enterprise transactional data will not be reflected in the data warehouse in real time, and queries made to the data warehouse may be out-of date by several hours. Additionally, in a large enterprise, several tens of Giga-bytes of data may be loaded into the data warehouse on a daily basis. Over time, the amount of data collected may exceed the capacity of the data warehouse.

### BRIEF DESCRIPTION OF THE DRAWINGS

Certain exemplary embodiments are described in the following detailed description and in reference to the drawings, in which:

FIG. 1 is a block diagram of a system configured to provide real-time operational business intelligence, in accordance with embodiments of the invention;

FIG. 2 is a block diagram of a Uniform Information Access System, in accordance with embodiments of the invention;

FIG. 3 is a process flow diagram of a method of processing a business intelligence request, in accordance with embodiments of the invention; and

FIG. 4 is a block diagram showing a non-transitory, computer-readable medium that stores code for modifying an executing query according to an embodiment of the invention.

### DETAILED DESCRIPTION OF SPECIFIC EMBODIMENTS

Embodiments of the invention provide real-time operational business intelligence. In accordance with embodiments, a Uniform Information Access system is provided, which enables information retrieval from a variety of structured and unstructured or semi-structured data sources. The Uniform Information Access system enables specific data to be gathered in a parallel fashion directly from a plurality of operational data sources, in response to a requested business intelligence operation such as a query, or report request, among others. In this way, data relevant in the enterprise can be accessed in real-time directly from the data sources themselves, rather than relying only on the data that has been previously stored to a data warehouse. Furthermore, utilizing the Uniform Information Access system can replace the traditional process of collecting all enterprise data into one centralized data warehouse. In this way, a large collection of historical enterprise data may be more easily maintained and accessed, without the risk of exceeding the storage capacity of a single data warehouse.

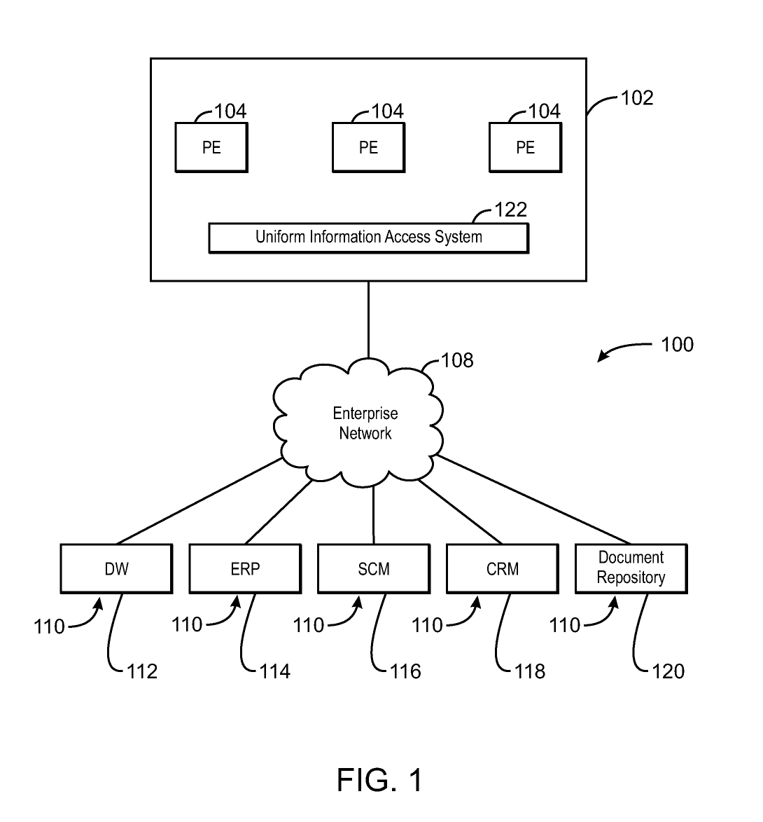

FIG. 1 is a block diagram of a system configured to provide real-time operational business intelligence, in accordance with embodiments of the invention. The system is generally referred to by the reference number 100. As illustrated in FIG. 1, the system 100 may include a computing device 102, which can be viewed as a cluster of traditional servers running a traditional operating system such as Linux or Windows. The computing device 102 can include one or more processing elements (PEs) 104. For example, the computing device 102 can include a central processing unit (CPU), or a cluster of symmetric multiprocessors (SMPs), among other configurations. The processing elements 104 run specialized application software for collecting relevant data from the different data sources in the enterprise. In an embodiment, the computing device 102 is a general-purpose computing device, for example, a cluster of one or more processing elements 104.

The computing device 102 can be operatively coupled to an enterprise network 108, which may be a local area network (LAN), a wide-area network (WAN), or another network configuration. Through the enterprise network 108, the computing device 102 can access a variety of operational data sources 110, including structured and unstructured data sources, such as data warehouses 112, data marts, a customer relations management (CRM) system 118, an Enterprise Resource Planning (ERP) system 114, document repositories 120, and the like. A data mart is a data storage system, such as a database, configured to support business needs of a department or a division in an enterprise. As used herein, the term “structured data” refers to a data wherein the semantic meaning of the stored data is explicitly defined. For example, a structured data source includes relational databases, XML databases, and the like. The term “unstructured data” is used to refer to a data source wherein the semantic meaning of the data is not explicitly defined. For example, unstructured data can refer to plain text documents, scanned documents, ADOBE® Portable Document Files (PDFs), Microsoft® Word documents. The term “unstructured data” is also used herein to refer to semi-structured data, wherein the semantic meaning of the data is encoded, for example, using metadata tags. Examples of semi-structured documents include eXtensible Markup Language (XML) files, and HyperText Markup Language (HTML) files, among others.

In embodiments, the system 100 includes an Enterprise Resource Planning (ERP) system 114 used to manage internal and external resources, such as financial resources, human resources, materials, equipment, and other tangible and intangible assets. The Enterprise Resource Planning system 114 can be used to provide a roadmap for future business plans of the enterprise, such as planned products, services, acquisitions, and the like and facilitate the flow of information throughout the enterprise and coordinate business operations of the enterprise.

The system 100 can include a supply chain management (SCM) system 116 used to manage the production of products and services provided to end customers. The supply chain management system 116 can be used to track and manage the movement and storage of raw materials, work-in-process inventory, and finished goods from the supplier to the customer.

The system 100 can also include a customer relations management (CRM) system 118 used to track and manage relationships with customers, business clients, and sales prospects of the enterprise. For example, the customer relations management system 118 may be used to keep track of sales activities, marketing activities, customer service interactions, customer complaints, technical support, and the like.

In embodiments, the system 100 includes one or more document repositories 120 used to store important enterprise documents, such as employee work product, technical papers, correspondence, contracts, invoices, legal documents, and the like. Documents stored to the document repository may include power point presentations, emails, PDFs, Microsoft® Word documents, spreadsheets, scanned documents, and the like. Those of ordinary skill in the art will appreciate that the configuration of the system 100 is but one example of a system may be implemented in an embodiment of the invention. Those of ordinary skill in the art would readily be able to define specific devices, systems, and operational data sources 110, based on design considerations for a particular system.

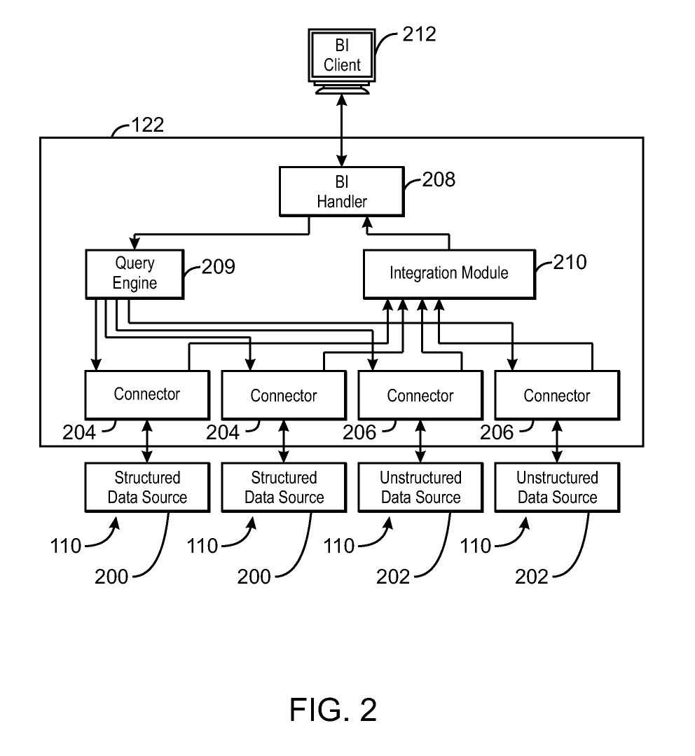

The computing device 102 also includes a Uniform Information Access System software 122 configured to execute various data gathering operations against the operational data sources 110, such as executing queries, generating reports, Online Analytical Processing (OLAP), among others. OLAP is a business intelligence technique used to quickly answer multi-dimensional analytical queries. As stated above, the Uniform Information Access System 122 enables relevant data to be gathered in a parallel fashion directly from a plurality of operational data sources 110, in response to a requested operation such as a query, or report request. Data may be gathered from each data source in a data format native to the particular data source and converted to a common data format utilized by the Uniform Information Access System 122. The requested operation may be performed on the gathered data and the results of the operation may be, for example, stored to a data structure and/or displayed to a user. The Uniform Information Access System 122 may be better understood with reference to FIG. 2.

FIG. 2 is a block diagram of a Uniform Information Access System, in accordance with embodiments of the invention. Components of the Uniform Information Access System 122 are a set of software modules that may leverage specialized hardware such as a solid state drive (SSD) or a field-programmable gate array (FPGA) to optimize execution. In embodiments, components of the Uniform Information Access System 122 are implemented in the computing device 102, which may be a cluster, as shown in FIG. 1.

As described above, the Uniform Information Access System 122 may be operatively coupled to one or more data sources 110, including structured data sources 200 and unstructured data sources 202. The Uniform Information Access System 122 includes a query engine 209 to generate relevant queries for the individual structured and unstructured data sources 110 involved. The query engine 209 can decompose a business intelligence operation into a set of queries to both structured and unstructured data sources. The query engine 209 generates appropriate queries to the corresponding connectors 204 (for structured data sources 200) and connectors 206 (for unstructured data sources 202). The connectors 204 and 206 acquire the -appropriate data from the corresponding data source 112.

Each connector 204 can be operatively coupled to a corresponding structured data source 200 such as a relational database, XML database, data warehouse, data mart, and the like. The connector 204 can be configured to perform a query of the corresponding structured data source 200 using the data model native to the particular structured data source 200 to which it is coupled. For example, the connector 204 may perform a database query using the structured query language (SQL) or XQuery on XML database, among others.

Each connector 206 may be operatively coupled to an unstructured data source 202, such as a document repository, Customer Relations Management (CRM) system, and the like. One or more documents in the unstructured data source 202 may include metadata tags, which provide semantic meaning to the data contained therein, for example, XML Files, HTML files and the like. The connector 206, for example, may perform the search of the unstructured content 202 using a semantic search engine.

The unstructured data source 202 may also include plain text, such as Microsoft® Word documents, PDFs, scanned documents, among others. The connector 206 may perform the search of the unstructured content 202 using a Natural Language Processor (NLP) to extract semantic meaning from the text. The particular techniques used to perform the search of the unstructured content may be tailored to the particular type of data that is stored to the corresponding unstructured data source 202. Further, embodiments are not limited to the number or type of data sources 110 shown in FIG. 2, as the Uniform Information Access System 122 may be scaled to accommodate any suitable number and type of data sources 110 that may be included in a particular implementation.

The Uniform Information Access System 122 can include a BI handler 208 and an integration module 210. The BI handler 208 can be configured to receive a Business Intelligence client requests from a client 212, for example, from a user or from analytics software. The business intelligence client request may be a query, requests for reports, OLAP style requests, or other business analytics related operations. In embodiments, the business intelligence client request may also include a context identifier that enables the query engine 209 to identify appropriate data sources for the business intelligence client request. The context identifier may include domain specific semantics that identify a particular context for the business intelligence client request. For example, the user may select a financial context in the enterprise, in which case the business intelligence client request may be applied to data sources 110 that correspond to the finances-related data sources in the enterprise. The BI handler 208 passes the BI request to the query engine 209, which is configured to issue appropriate query or search requests to the relevant connectors.

The integration module 210 collects the returned results from the appropriate data sources 110 through the connectors 204 and 206. The connectors 204 and 206 transform the returned data from a data source to a common data representation such as such as a Resource Description Framework (RDF) specified by the World Wide Web Consortium (W3C). The connectors 204 and 206 also reconcile the semantics between different data sources 110. For example, one data source 110 may refer to home address information as “home address” while another data source 110 may refer to the same type of information as “residence address”. The connectors 204 and 206 can be configured to determine that both phrases refer to the same type of information and convert the information to a common semantic representation. For example, the connectors 204 and 206 can be configured to convert instances of “residence address” to “home address” or some other common phrase. The connectors 204 and 206 also reconcile the semantics between the data sources 110 and the domain specific semantics included in the context identifier, which may be provided in the business intelligence client request.

In embodiments, the combined data returned from the relevant connectors are stored into a common data store. If RDF is used as the common data representation format, the common data store may be referred to as a “triple store.” For example, a triple store can be implemented using ORACLE® 11G, JENA, 3STORE, SESAME, BOCA, or other available software.

The BI handler 208 may perform the requested business intelligence client request using the common data set generated by the integration module 210. For example, the BI handler 208 may perform a SPARQL query on the triple store containing the returned triples from the integration module 210. Furthermore, the BI handler 208 may generate a report, create a multidimensional OLAP structure, or perform reasoning with ontology on the triples in the triple store using Web Ontology Language (OWL). Other business intelligence client requests that may be performed by the BI handler 208 include analytics such as data mining, statistical analysis, predictive analytics, business process modeling, and other business analytics.

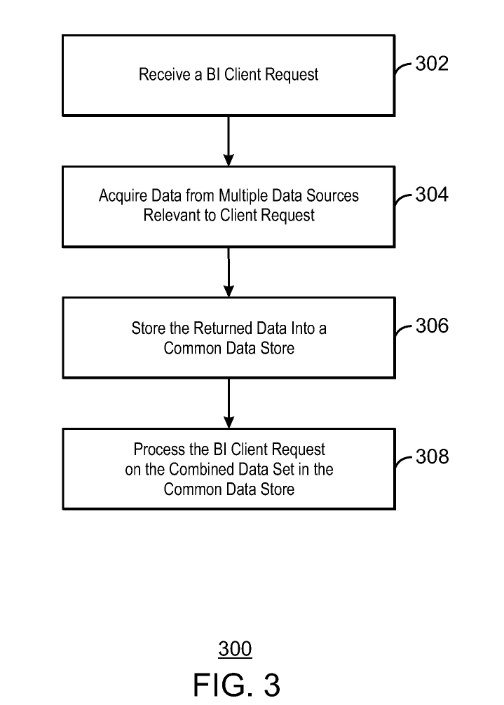

FIG. 3 is a process flow diagram of a method of processing a business intelligence request, in accordance with embodiments of the inventions. The method is referred to by the reference number 300. At block 302, a business intelligence client request is received, for example, from a user or analytics software. In embodiments, the business intelligence client request is received by the BI handler 208 of the Uniform Information Access System 122, as discussed in relation to FIG. 2. The business intelligence client request enables the client to acquire information that exists in one or more data sources including structured data sources, such as relational databases, and unstructured data sources such as text files, which may or may not include metadata. For example, the business intelligence client request may be a query requesting the identification of all customers who have purchased greater than a specified amount of goods and also have unresolved customer complaints within the recent month. The data pertaining to customer purchases may be located in the Data Warehouse 112 (FIG. 1), which is a structured data source. The data pertaining to customer complaints may be stored in the Customer Relations Management system 118, which may be an unstructured data source.

At block 304, data may be acquired from multiple data sources 110 based on the business intelligence client request and the associated context. The data acquired from each data source 110 may be acquired according to the data format native to the data source. In embodiments, the BI handler 208 sends the business intelligence client request to the query engine 209 module, which issues any number of suitable searches or queries to the relevant data sources. For example, the query engine 209 may generate one or more SQL queries to be processed by the connector 204 of the corresponding structured data sources 200. The query engine 209 may also generate a search request to be processed by the connector 206 of the corresponding unstructured data sources 202. Continuing the example from block 302, the query engine 209 may initiate a SQL query to the Data Warehouse 112 to identify all customers that have purchased greater than the specified amount of goods within the recent month. Further, query engine 209 may initiate a search to the customer relations management system 118 to identify all customers that have unresolved complaints within the recent month, for example, using a semantic search engine or a Natural Language Processor engine as discussed above in relation to FIG. 2.

At block 306, the data gathered from all of the relevant data sources 110 are compiled into a combined data set in a single data store repository. The combined data set represents the union of each data set returned by the several data gathering operations. Additionally, the data from each data source may be converted into a common data format, such as the Resource Description Framework (RDF) data model, XML, Entity/Relationship model, or other structured data format. In embodiments, some of the data received from the connector 206 may already be represented in the appropriate data model. For example, the natural language processor used by the connector 206, may encode the structured data extracted from the unstructured data source 202 in the Resource Description Framework (RDF) data model. In embodiments, data sets that are not encoded in the common data format may be converted to the common format by the connector 206.

At block 308, the BI handler 208 at this point can perform the requested business intelligence operation on the combined data set generated by the integration module 210. In embodiments, the business intelligence client request is processed by the BI handler 208 using as an example the semantic Web Query language (SPARQL), or the Web Ontology Language (OWL), or others as discussed in relation to FIG. 2. Following the example provided above, the query performed by the BI handler 208 can return the intersection of the individual data sets acquired from the Data Warehouse 112 and the Customer Relations Management system 118. In other words, the business intelligence client request would return all customers who have purchased greater than a specified amount of goods and also have a customer complaint within the recent month. As discussed above, the BI handler 208 can also perform other types of business intelligence client requests such as queries, requests for reports, OLAP requests, data mining, statistical analysis, predictive analytics, business process modeling, or combinations thereof.

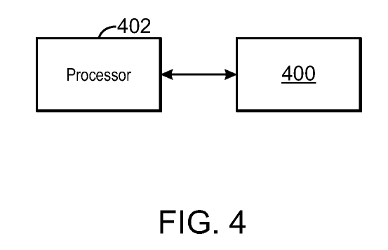

FIG. 4 is a block diagram showing a non-transitory, computer-readable medium that stores code for providing real-time operational business intelligence, according to an embodiment of the invention. The non-transitory, computer-readable medium is generally referred to by the reference number 400. The non-transitory, computer-readable medium 400 may correspond to any typical storage device that stores computer-implemented instructions, such as programming code or the like. For example, the non-transitory, computer-readable medium 400 may include one or more of a non-volatile memory, a volatile memory, and/or one or more storage devices. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, optical drives, and flash memory devices.

A processor 402, which may be a processing element 104 as shown in FIG. 1, generally retrieves and executes the instructions stored in the non-transitory, computer-readable medium 400 to process a business intelligence operation in accordance with embodiments of the Unified Information Access System 122 describe herein. As discussed above, the processor 402 may be configured to receive a business intelligence request and acquire data from the two or more data sources based on the business intelligence request. Some of the data is acquired from a first data source according to a first data format native to the first data source, and some of the data is acquired from a second data source according to a second data format native to the second data source. The processor can convert the data into a common format and store the data into a combined data set. The processor performs the business intelligence request on the combined data set.

What is claimed is:

1. A method, comprising:
receiving a business intelligence client request;
acquiring data from a plurality of data sources relevant to the business intelligence client request, wherein a first portion of the data is acquired from a first data source in a first data format native to the first data source, and a second portion of the data is acquired from a second data source in a second data format native to the second data source;
converting the data into a common data format and storing the data to a common data store; and
processing the business intelligence client request on the common data store.

2. The method of claim 1, wherein the first data source is a structured data source and the second data source is an unstructured data source.

3. The method of claim 2, wherein acquiring data from the second data source comprises using a natural language processor to extract structural information from the unstructured data source.

4. The method of claim 1, comprising converting the data acquired from the plurality of data sources into a common semantic representation.

5. The method of claim 1, wherein the business intelligence client request is decomposed into a set of queries to both structured and unstructured data sources.

6. The method of claim 1, comprising receiving a contextual indication associated with the business intelligence client request, wherein the contextual indication is used to identify the plurality of data sources relevant to the business intelligence client request.

7. The method of claim 1, wherein converting the data into a common format comprises converting the data into a World Wide Web Consortium Resource Description Framework (W3C RDF) data model.

8. The method of claim 1, wherein processing the business intelligence request on the combined data set comprises using a semantic Web programming language.

9. The method of claim 1, wherein the business intelligence client request comprises a query, a request for a report, OLAP, data mining, statistical analysis, predictive analytics, business process modeling, or combinations thereof.

10. A computer system comprising:
a Processing Element (PE); and
a set of software modules that are configured to direct the processing element to:
receive a business intelligence client request;
acquire data from the a plurality of data sources relevant to the business intelligence client request, wherein a first portion of the data is acquired from a first data source in a first data format native to the first data source, and a second portion of the data is acquired from a second data source in a second data format native to the second data source;
convert the data acquired from the plurality of data sources into a common representation format and store the data into a common data store; and
process the business intelligence client request on the combined data set.

11. The computer system of claim 10, wherein the first data source is a structured data source and the second data source is an unstructured data source.

12. The computer system of claim 11, wherein the set of software modules are configured to direct the processing element to acquire data from the second data source by using a Natural Language Processor (NLP) to extract structural information from the unstructured data source.

13. The computer system of claim 10, wherein the set of software modules are configured to direct the processing element to receive a contextual indication from the client associated with the business intelligence client request, wherein the contextual indication identifies the plurality of data sources.

14. The computer system of claim 10, wherein the set of software modules are configured to direct the processing element to convert the data into a common data representation format by converting the data to a Resource Description Framework (W3C RDF) data model, and wherein the processing of the business intelligence client request on the combined data set uses the World Wide Web Consortium (W3C) SPARQL query language.

15. The computer system of claim 10, wherein the business intelligence client-request is a query, a report, OLAP, data mining, statistical analysis, predictive analytics, business process modeling, or combinations thereof.

16. A non-transitory, computer-readable medium, comprising instruction configured to direct a processor to:
receive a business intelligence request;
acquire data from a plurality of data sources relevant to the business intelligence client request, wherein a first portion of the data is returned from a first data source according to a first data format native to the first data source, and a second portion of the data is acquired from a second data source according to a second data format native to the second data source;
convert the data returned from the plurality of data sources into a common format and store the data into a common data store; and
process the business intelligence client request on the combined data set.

17. The non-transitory, computer-readable medium of claim 16, wherein the first data source is a structured data source and the second data source is an unstructured data source.

18. The non-transitory, computer-readable medium of claim 16, comprising instructions configured to direct the processor to identify a data source of the plurality of data sources and generate a query of the data source according to a data format native to the data source.

19. The non-transitory, computer-readable medium of claim 16, wherein converting the data returned from the plurality of data sources into a common format comprises converting the data to a W3C Resource Description Framework (RDF) data model, and wherein the processing the business intelligence client request on the combined data set comprises using World Wide Web Consortium (W3C) SPARQL query language.

20. The non-transitory, computer-readable medium of claim 16, wherein the business intelligence client request comprises a query, a report, OLAP, data mining, statistical analysis, predictive analytics, business process modeling, or combinations thereof, and wherein the business intelligence client request uses data from both structured data and unstructured data in an enterprise.
